(19) United States
(12) Patent Application Publication
(10) Pub. No.: US 2012/0158478 A1
(43) Pub. Date: Jun. 21, 2012

(54) MARKET RESEARCH AND CONSUMER AD REVENUE SHARE SYSTEM

(76) Inventor: CURTIS BINGHAM HOLDER, Huntersville, NC (US)

(21) Appl. No.: 13/198,270

(22) Filed: Aug. 4, 2011

Related U.S. Application Data
(60) Provisional application No. 61/424,513, filed on Dec. 17, 2010.

(51) Int. Cl. G06Q 30/00

(52) U.S. Cl. 705/14.19

(57) ABSTRACT

A user payment system coupled over a public communication network, designed to automatically enable an advertiser to pay a user for answering a survey question placed on a content provider web page and managed by an ad survey controller. There is a central server module, coupled to the internet, having a server engine module, a web management module, and a content management module. There is also an advertiser module, coupled to the central server via the public communication network, designed to provide an advertisement to the central server module, and to provide advertising compensation. There is additionally a content provider module, coupled to the central server module via the public communication network, designed to provide a web page of content to the central server. There is also included an ad survey controller module, coupled to the central server module via the public communication network, designed to provide a survey question to the central server module, wherein the survey question is associated with the advertisement. Additionally, there is a user module, coupled to the central server module via the public communication network, designed to enable the user to view the advertisement and answer the survey question, whereby the user is paid a portion of the advertising compensation upon completing the survey question.

### CROSS-REFERENCE TO RELATED APPLICATIONS

This invention claims of priority, under 35 U.S.C. §120, to U.S. Provisional Patent, Application No. 61/424,513, which is incorporated by reference herein. This invention claims no priority, under 35 U.S.C. §119, to any foreign Patent Application, which would be incorporated by reference herein. This application is not a Divisional Application of, under 35 U.S.C. §121, and claims no priority under 35 U.S.C. §121, to a United States Non-Provisional Application.

### COPYRIGHT RESERVATION NOTICE

A PORTION OF THE PRESENT DISCLOSURE AND DRAWINGS OF THIS PATENT DOCUMENT AND APPENDICES CONTAIN MATERIAL THAT IS SUBJECT TO COPYRIGHT PROTECTION. THE COPYRIGHT OWNER HAS NO OBJECTION TO THE FACSIMILE REPRODUCTION BY ANYONE OF THIS PATENT DOCUMENT OR THE PATENT DISCLOSURE, AS IT APPEARS IN THE PATENT AND TRADEMARK OFFICE PATENT FILES OR RECORDS, BUT OTHERWISE RESERVES ALL COPYRIGHTS WHATSOEVER.

### BACKGROUND OF THE INVENTION

1. Field of the Invention

The present invention relates to systems and methods for consumers to be compensated for participating in ads posted on internet sites by vendors. Specifically, the invention relates to an interactive viewing and participation system for consumers to provide valuable market information and feedback to the vendors or advertisers, wherein the consumer receives instant compensation for their participation.

2. Description of the Related Art

In the related art, it has been known to use methods and systems that are directed to motivate the internet consumer to access an ad posted on an internet site, or to respond and participate to a “pop-up” ad while searching for information on the internet. When a consumer accesses these ads, they subsequently provide valuable information on the product, or demographic information that can be used to improve sales, product quality and even product functionality. These methods and systems generally use the lure of winning a prize, or receiving something for free to entice the consumer to participate. Some improvements have been made in the field. Examples of references related to the present invention are described below, and the supported teachings of each reference are incorporated by reference herein:

U.S. Patent Application No.: 2007/0276728, published Nov. 29, 1997 to Bala, discloses a Software Application with embedded advertisements to facilitate ad funded software development. Advertisements are embedded in software applications based on the commands that the application supports. In one embodiment, developers, advertisers and software users are able to perform queries for commands. This capability simplifies the process of identifying instances of advertisements and opportunities for advertisements.

U.S. Patent Application No.: 2006/0247999, published Nov. 2, 2006 to Gonen et al., discloses a process for dynamic routing of customer contacts to service providers in real time. This includes establishing accounts in a service provider contact system for a plurality of service providers. The plurality of service providers are permitted to bid against one another for providing goods and services to a consumer. A contact list is created of service providers ranked from a lowest bidder service provider to a highest bidder service provider. A contact is received from a customer and routed from the customer to the lowest bidder service provider on the contract list. The service provider account receiving the contact and fulfilling the transaction is credited to amount bid by the service provider.

U.S. Patent Application No.: 2007/0067219, published Mar. 22, 2007 to Altberg et al., discloses a method and apparatus to manage multiple advertisements. In one embodiment, a method includes: generating a user interface to show advertisements simultaneously and to allow editing of any of the advertisements; and updating an advertisement database according to input received in the user interface. In another embodiment, each advertisement is changed for according to a price bid in response to a communication lead generated from the ad. In yet another embodiment, the ads are selected from advertisements of more than one user.

U.S. Patent Application No.: 2008/0010153, published Jan. 10, 2008 to Pugh-O'Connor et al., discloses a computer network provided digital content under an advertising and revenue sharing basis, such as music provided via the internet with time shifted ads presented by a client resident application. The system may provide music to users via the internet, in combination with time shifted ads presented by an application that resides on the user's computer. The system receives digital ads from advertisers and digital content from content providers. Advertisers provide compensation based on the presentation of their advertisements to users. Content providers receive a variable amount of compensation based on how many users access the digital content during a particular time period. Each content provider may receive a share of the advertising revenue that is generated by each user that access content during a particular time period.

U.S. Patent Application No.: 2008/0091611, published Apr. 17, 2008 to Lapstun et al., discloses a user interaction causing click facilitator to collect sales commission fees.

U.S. Patent Application No.: 2008/0088581, published Apr. 17, 2008 to Lapstun et al., discloses an online ad placement in response to a zone of paper input. The method displays an ad to a user via user interaction with a printed substrate. The substrate comprising user information and coded data enabling the user interaction, said method comprising: a) a user performing interaction with the substrate using a sensing device that reads at least some of the coded data when operatively positioned or moved relative to the substrate and generating interaction data using the dead coded data, said interaction data being indicative of the user interaction; and b) said user interaction causing a first resource to be displayed on a display device, said first resource being blended resource comprising at least one advertisement and content corresponding to said user interaction, wherein said at least one advertisement is determined by a zone of said user interaction.

U.S. Patent Application No.: 2008/0091527, published Apr. 17, 2008 to Silverbrook et al., discloses a method of charging for ads associated with predetermined concepts. The method includes obtaining a fee associated with an ad provided to a user in response to the user interacting with a printed substrate. Whereby the method includes: a) accepting a bid from an advertiser for provision of the ad when the user interaction invokes a predetermined concept, b) selecting the ad for provision to the user when the user interaction invokes the predetermined concept, d) providing the ad to the user, and d) charging a fee to the advertiser after any event selected from the croup comprising: the ad being provided to the user, the user clicking on a hyperlink on the ad, and the user completing a purchase via the ad.

U.S. Patent Application No.: 2008/0010425, published Jan. 10, 2008 to Wright et al., discloses a system and method for enabling bi-directional communication between providers and consumers of information in multi level markets using a computer network. The system of the invention provides a database having accounts for providers and consumers. Each account contains contact, warranty, product, system usage, and billing information for providers, and contact, demographic, product preferences, contact permissions, and usage history information for consumers. The invention provides an area for consolidation of all provider access points in a taskbar on the user's computer. the invention creates an ad reviewing cart that allows users to select providers and content to be received. An information warehouse manager is employed to receive data from providers and users. A commission accounting module calculates commissions.

U.S. Pat. No. 7,580,858, issued Aug. 25, 2009 to Almeida, discloses an advertising revenue sharing method where all parties involved in producing the income stream for a content distributor is presented. The content hosting site, the content writer and the user doing the interaction with paid contents receive a first share of the generated income stream.

U.S. Patent Application No.: 2006/0247971, published Nov. 2, 2006 to Dresden et al., discloses an advertising revenue system for wireless telecommunications providers using the sharing of display space of wireless devices. The present invention assists the critical real time decision making required to make important decisions on bidding on various customer procurement commodities in a wireless display advertising markets. The invention provides dynamic pricing as a function of the criteria of the wireless advertising criteria, such as exposures, type of advertisers and geography. In a preferred embodiment, the present invention is a virtual or physical e-commerce application with an interface connected to the wireless advertisement procurement vendors. A pool of bidders can analyze any tracking data for effective placement in the wireless advertising spaces, such as cell phones, PDAs, or laptops connected to a public or private WAN, based on a number of factors.

U.S. Patent Application No.: 2007/0130015, published Jun. 7, 2007 to Starr al., discloses an advertisement revenue sharing for distributed video. The method modifies video to incorporate a tag that associates the video with an advertisement and facilitates payment of a share of advertising revenue to an owner of the video when the video and its associated advertisement are displayed at a client device.

The inventions heretofore known suffer from a number of disadvantages. There does not exist a method or system that is set up to compensate the consumer directly with a percentage of revenue generated from the ad host site and others based on the consumer providing active consumer feedback to the advertiser by answering questions about the advertisement or product being advertised. The present invention, outlined with the accompanying figures, provides a method and system for a consumer and market research companies to collect consumer feedback actively provided by the consumer and to provide those consumers with revenue that is a percentage of the cost of the ad paid by the advertiser to the hosting ad site and others.

What is needed is a method or system that is set up to compensate the consumer directly with a percentage of revenue generated from the ad host site and simultaneously provide the advertiser with valuable marketing information, that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available computer case designs. Accordingly, the present invention has been developed to provide a method or system that is set up to compensate the consumer directly with a percentage of revenue generated from the ad host site and others, based on the consumer providing active consumer feedback to the advertiser by answering questions about the advertisement or product being advertised. The present invention, outlined with the accompanying figures, provides a method and system for a consumer and a market research companies to collect consumer feedback actively provided by the consumer and to provide those consumers with revenue that is a percentage of the cost of the ad paid by the advertiser to the hosting ad site and others.

There is in one embodiment, provided a user payment system coupled over a public communication network, designed to automatically enable an advertiser to pay a user for answering a survey question placed on a content provider web page and managed by an ad survey controller. There may be included a central server module, coupled to the internet, having a server engine module, a web management module, and a content management module. There may also be included an advertiser module, coupled to the central server via the public communication network, designed to provide an advertisement to the central server module, and to provide advertising compensation. There may be included a content provider module, coupled to the central server module via the public communication network, designed to provide a web page of content to the central server. There may be included an ad survey controller module, coupled to the central server module via the public communication network, designed to provide a survey question to the central server module, wherein the survey question is associated with the advertisement. There may be included a user module, coupled to the central server module via the public communication network, designed to enable the user to view the advertisement and answer the survey question, whereby the user is paid a portion of the advertising compensation upon completing the survey question.

In another embodiment, there is a system of machines, designed to display an advertisement on a web page of a content provider to a user, and enable the user to be paid to answer a survey question, coupled to the advertisement, provided by an ad survey controller. This may include a central server machine, designed to provide communication between the advertiser, ad survey controller, content provider, and user. This may include a content provider machine, coupled to the central server machine, designed to provide content to the central server machine. This may also include an ad survey controller machine, coupled to the central server machine, designed to provide a combined advertisement and survey question to the central server machine. This may include a user machine, coupled to the central server machine, designed to access the content and the combined advertisement and survey question that are attached to the content, designed to, when the survey question is completed, cause the ad survey controller machine to move an associated credit to the content provider machine and the user machine.

In another embodiment, there may be an apparatus, designed to attach a combined ad and survey to a web page, and enable a user to get a credit after completing work on the survey. This may comprise a content provider apparatus, having a content provider account, and designed to create and provide a web page to the user. This may comprise an ad survey apparatus, designed to attach the combined ad and survey to the web page. This may also comprise a user apparatus, coupled to the content provider and ad survey apparatus, designed to cause the ad survey apparatus to create a credit for the content provider and user apparatus when the survey is completed.

Reference throughout this specification to features, advantages, or similar language that does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates a schematic of a multimedia console, apparatus, computer or machine;

FIG. 2a illustrates a schematic of how the machine of FIG. 1 is associated with the public communication network and a server computer, apparatus, or machine;

FIG. 2b illustrates a schematic of FIG. 2 in a larger system;

FIG. 3 illustrates a schematic of a prior art system of how an advertiser, user, content provider all communicate through a central server;

FIG. 4 illustrates a prior art schematic of the operation of FIG. 3;

FIG. 5 illustrates a schematic of an embodiment of the invention as it advances the teaching of prior art FIG. 3;

FIG. 6 illustrates a schematic of an embodiment of the invention as it advances the teaching of prior art FIG. 4;

FIG. 7 illustrates a schematic of an embodiment of the invention as it advances the teaching of prior art FIG. 4 and continues from FIG. 6;

FIG. 8 illustrates a schematic of an embodiment of the invention as it advances the teaching of prior art FIG. 4 and continues from FIGS. 6 and 7;

FIG. 9 illustrates a schematic of an embodiment of the invention as it advances the teaching of prior art FIG. 4 and continues from FIGS. 6, 7 and 8;

FIG. 10 illustrates a schematic of an embodiment of the invention as it advances the teaching of prior art FIG. 4 and continues from FIGS. 6, 7, 8 and 9;

FIG. 11 illustrates a web page by a content provider displaying the bumble bee icon attached to regular advertisements of Kim Komando;

FIG. 12 illustrates a web page by a content provider displaying the bumble bee icon attached to regular advertisements of ESPN;

FIG. 13 illustrates a web page by a content provider displaying the bumble bee icon attached to regular advertisements of the University of Phoenix;

FIG. 14 illustrates a blow up portion of the web page from FIG. 13 by a content provider displaying the bumble bee icon attached to regular advertisements of the University of Phoenix;

FIG. 15 illustrates a web page display when a User hovers over the bumble bee icon to show the amount of pay for participating in the survey; and

FIG. 16 illustrates a web page display when a User is directed to the survey.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

As used herein, “and,” and grammatical equivalents thereof is intended to be inclusive or open-ended that does not mean that all of the elements in the list must be included. Specifically, the term “and” can be viewed as an equivalent of the commonly used phrase “and/or”, which is intended to create an unrestricted list of elements that may or may not require all of the elements to be included therein.

Reference is made throughout the specification and claims to the term “module” to more particularly emphasize, for example their implementation independence. For example, a module may be implemented as a hardware circuit comprising custom VLSI circuits or gate arrays, off the shelf semiconductors, such as logic chips, transistors, or other discrete component. A module may also be implemented in programmable hardware devices such as a field programmable gate array, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables or an identified module need not be physically located together, but may comprise disparate instructions stored in different locations, which, when joined logically together, comprise the module and achieve the stated purpose for the module.

Indeed, a module of executable code may be a single instruction, or many instructions, and may even be distributed over several different code segments, among different programs, and across several memory devices. Similarly, operationally data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The present invention has been developed in response to the present state of the art, and in particular, in one embodiment, in response to the problems and needs in the art that have not yet been fully solved. Accordingly, the present invention has been developed to provide an advertiser with feedback from the viewers of their product ads and share the payments that the advertiser pays for the product advertisement.

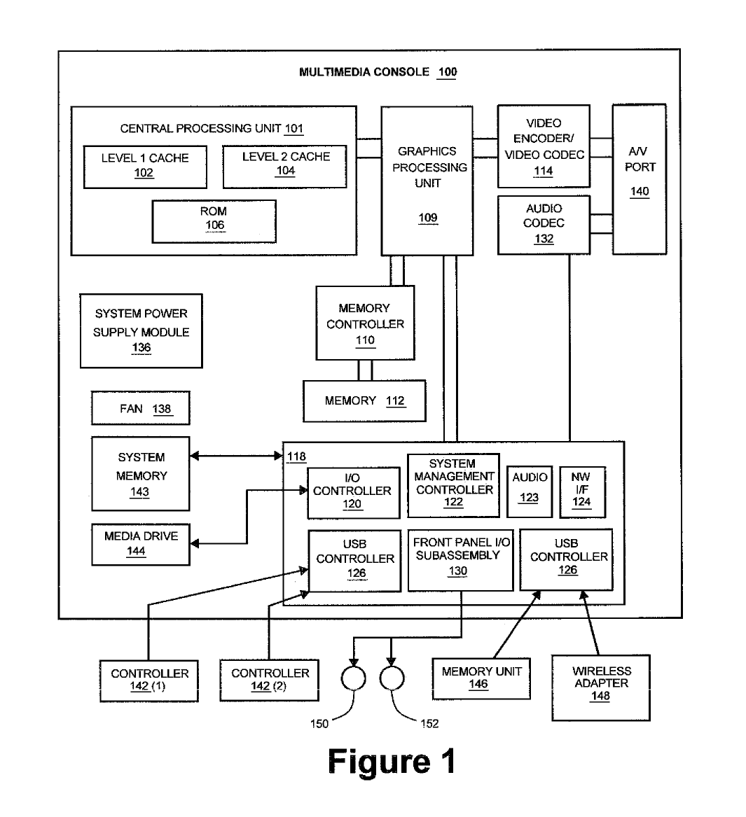

FIG. 1 illustrates the functional components of a specialty machine in the form of a multimedia console 100 in which certain aspects of the present invention may be implemented. The machine 100 has a central processing unit (CPU) 101 having a level 1 cache 102, a level 2 cache 104, and a flash ROM (read only memory) 106. the level 1 cache 102 and the level 2 cache 104 temporarily store data and hence reduce the number of memory access cycles, thereby improving processing speed and throughput of the machine 100. The CPU 101 may be provided having more than one core, and thus, additional levels of caches. The flash ROM 106 may store an executable code(s) that is loaded during an initial phase of a boot process when the machine 100 is powered on.

A graphics processing unit (GPU) 109 and a video encoder or video codec (coder/decoder) 114 form a video processing pipeline for high speed and high resolution graphics processing. Data is carried from the graphics processing unit 109 to the video encoder/video codec 114 via a bus. The video processing pipeline outputs data to an AV (audio/video) port 140 for transmission to a television or other display. A memory controller 110 is connected to the GPU 109 to facilitate processor access to various types of memory 112, like a RAM (random access memory).

The machine 100 includes an I/O controller 120, a system management controller 122, an audio processing unit 123, a network interface controller 124, a first USB host controller 126, a second USB controller 128, and a front panel I/O subassembly 130 that are preferably implemented on a module 118. The USB controller 126 serve as hosts for peripheral controllers 142(1)-142(2), a wireless adapter 148, and an external memory device 146, like flash memory, external CD/DVD ROM drive, removable media. The network interface 124 and wireless adapter 148 provide access to a network, like the internet, home network, and may be any of a wire variety of various wired or wireless interface components including an Ethernet card, a modem, a Bluetooth module, a cable modem, and the like.

System memory 143 is provided to store application data that is loaded during the boot process. A media drive 144 is provided and may comprise a DVA/CD drive, hard drive, or other removable media drive. The media drive 144 may be internal or external to the machine 100. Application data may be accessed via the media drive 144 for execution, playback, etc. by the machine 100. The media drive 144 is connected to the I/O controller 120 via a bus, such as a Serial ATA bus or other high speed connection, like IEEE-1394.

The system management controller 122 provides a variety of service functions related to assuring availability of the machine 100. The audio processing unit 123 and an audio codec 132 form a corresponding audio process pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the ejection button 152, as well as any LEDs (light emitting diodes) or other indicators exposed on the outer surface of the machine 100. A system power supply module 136 provides power to the components of the multimedia console 100. A fan 138 cools the circuitry within the machine 100.

The CPU 101, GPU 109, memory controller 110, and various other components within the machine 100 are interconnected via one or more buses, including serial and parallel buses, a memory bus, a peripheral bus, and a processor or local bus using any of a variety of bus architectures.

When the machine 100 is powered ON, application data may be loaded from the system memory 143 into memory 112 and caches 102, 104 and executed on the CPU 101. The application may present a graphical user interface that provides a consistent user experience when navigating to different media types available on the machine 100. In operation, applications and other media contained within the media drive 144 may be launched or played from the media drive 144 to provide additional functionalities to the machine 100.

The machine 100 may be operated as a standalone system by simply connecting the system to a television or other display. In this standalone mode, the machine 100 allows a user to interact with the system, watch movies, or listen to music, for example. However, with the integration of broadband connectivity made available through the network interface 124 or the wireless adapter 148, the machine 100 may further be operated as a participant in a larger network community, like the world wide web, cloud computing, or the internet.

When the machine 100 is powered ON, a set amount of hardware resources are reserved for system use by the machine operating system. These resources may include a reservation of memory (e.g. 16 MB), CPU and GPU cycles (e.g. 5%), networking bandwidth (e.g. 8 kbs), etc. Because these resources are reserved at system boot time, the reserved resources do not exist from the application's view.

In particular, the memory reservation preferably is large enough to contain the launch kernel, concurrent system applications, and drivers. The CPU reservation is preferably maintained at a constant level.

With regard to the GPU reservation, lightweight messages generated by the system applications (e.g. popups) are played by using a GPU interrupt to schedule code to render popup into an overlay. The amount of memory required for an overlay depends on the overlay area size and the overlay preferably scales with screen resolution. Where a full user interface is used by the concurrent system applications, it is preferably to use a resolution independent of game resolution. A scalar may be used to set this resolution such that the need to change frequency and cause a TV resynch is eliminated.

After the machine 100 boots and system resources are reserved, concurrent system applications execute to provide system functionalities. The system functionalities are encapsulated in a set of system applications that execute within the reserved system resources described above. The operating system kernel identifies threads that are system application threads versus multimedia applications threads. The system applications are preferably scheduled to run on the CPU 101 at predetermined times and intervals in order to provide a consistent system resource view to the applications. The scheduling is to minimize cache disruption for the multimedia application running on the machine 100.

When a concurrent system application requires audio, audio processing is scheduled asynchronously to the multimedia application due to time sensitivity. A multimedia console application manager controls the multimedia application audio level when system applications are active.

Input devices (e.g., controllers 142(1) and 142(2)) are shared by multimedia applications and systems applications. The input devices are not reserved resources, but are to be switched between system applications and the multimedia applications such that each will have a focus of the device. The application manager preferably controls the switching of input stream, without knowledge the multimedia application's knowledge and a driver maintains state information regarding focus switches.

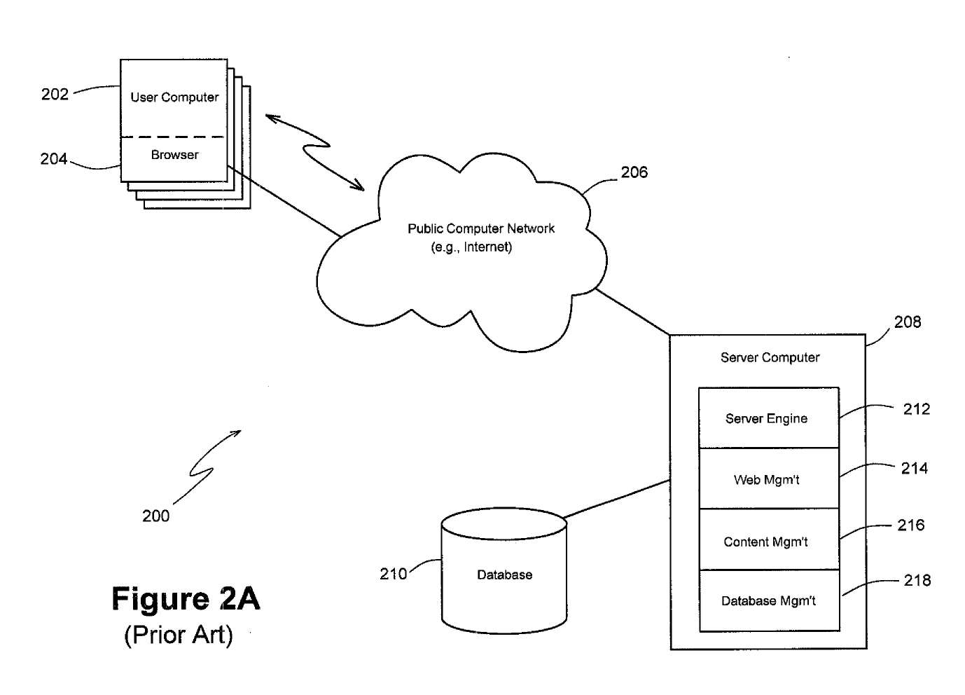

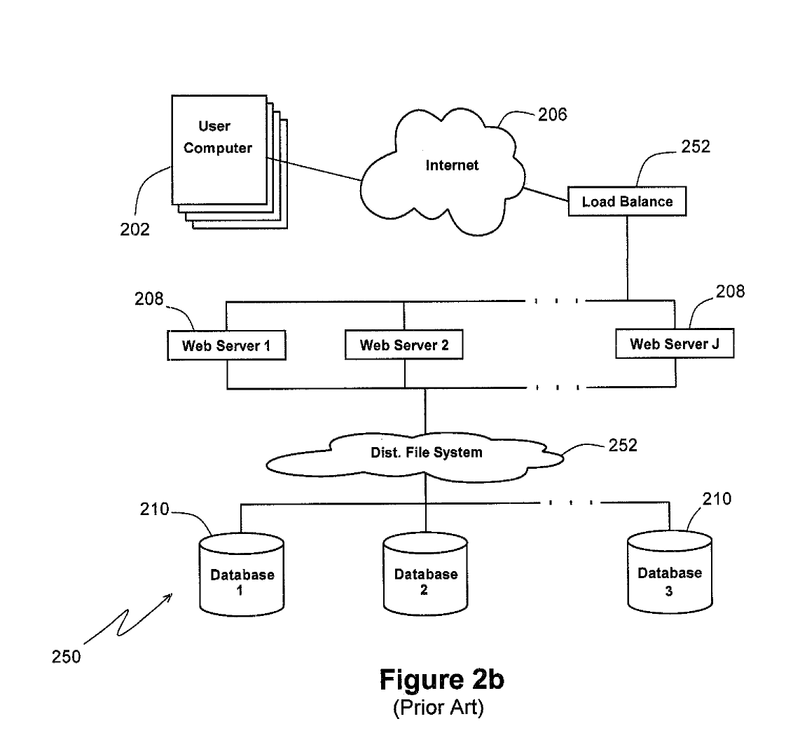

Aspects of the invention may be practiced in a variety of other computing environments. For example, referring to FIG. 2A, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, which is also referred to as a public communication network, performs many or all of the functions for receiving, routing, and storing of electronic messages, such as web pages, audio signals, and electronic images. While the Internet is shown, a private network, such as an intranet, may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores many of the web pages and content exchanged between the user computers, including digital content and advertisements. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216, and a database management component 218. The server engine performs basic processing and operating system level tasks. The web page management component handles creation and display or routing of web pages or screens associated with receiving and providing digital content and advertisements. Users may access the server computer by means of a URL associated therewith. The content management component handles most of the functions in the embodiments described herein. The database management component includes storage and retrieval tasks with respect to the database, queries to the database, and storage of data such as video, graphics, and audio signals.

Referring to FIG. 2B, an alternative embodiment to the system 200 is shown as a system 250. The system 250 is substantially similar to the system 200, but includes more than one server computer (shown as server computers 1, 2, . . . J). A load balancing system 252 balances load on the several server computers. Load balancing is a technique well-known in the art for distributing the processing load between two or more computers, to thereby more efficiently process instructions and route data. Such a load balancer can distribute message traffic, particularly during peak traffic times.

A distributed file system 254 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

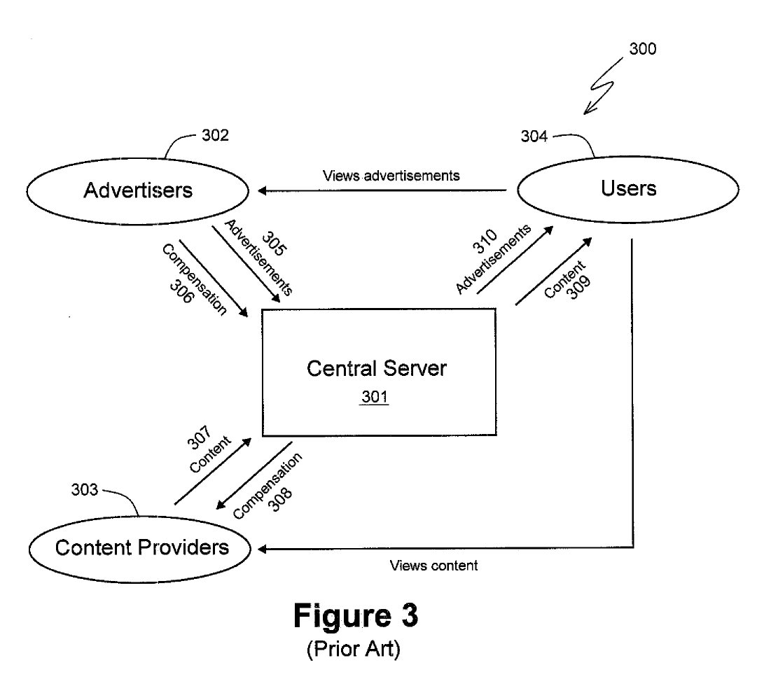

FIG. 3 illustrates one prior art example of the system for providing digital content to users under an advertising and revenue sharing basis is described. In some examples, the system may provide music to users via the Internet, in combination with time-shifted advertisements presented by an application that resides on the user's computer system. A central server 301 receives digital advertisement data 305 from advertisers 302. Advertisers 302 provide compensation 306 based on the presentation of their advertisements 310 to users 304. The central server 301 receives digital content 307 from content providers 303. Digital content may be audio content, visual content, audiovisual content, applications, or other content. Content providers 303 receive a variable amount of compensation 308 based on how many users 304 access the digital content 309 during a particular time period (e.g., one week, one month, or another time period) or based on other usage data. The system provides user-selected digital content 309 and user-targeted digital advertisements 310 to users 304. Further details are provided below.

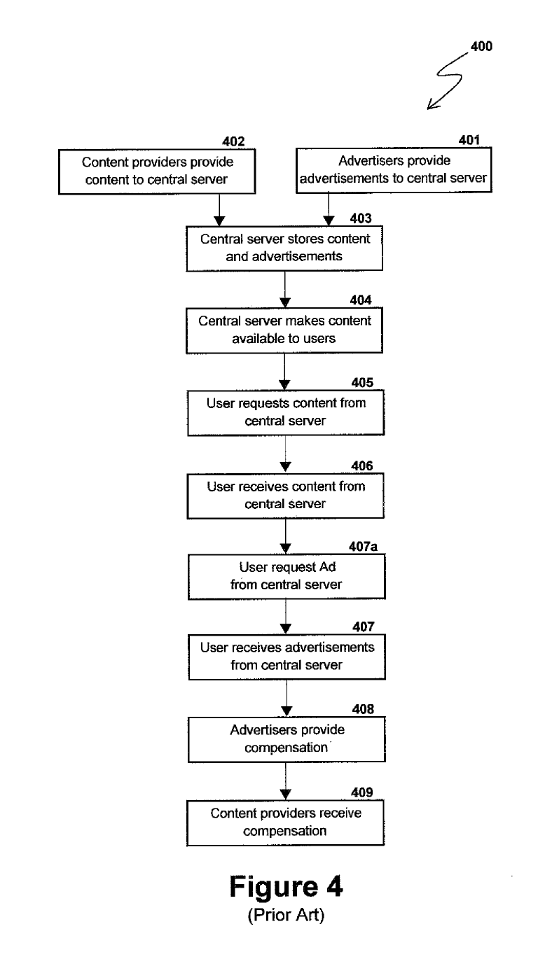

FIG. 4 illustrates one embodiment of a process 400 by which the system may provide digital content to users under an advertising and revenue sharing basis. At a block 401 advertisers provide digital advertisement data to the system. An advertisement may be any announcement designed to attract a user's attention, including, but not limited to, a web address to be launched in a browser window by the system. The web address may be an address for an advertiser's web site or web page. Each advertiser may specify one or more targeting criteria, including but not limited to keywords, to be associated with each of its advertisements. A keyword is a word or phrase that may trigger the system to provide the advertisement to a user. In some examples, the system may prohibit an advertiser from purchasing targeting criteria that are not relevant to the products or services offered by the advertiser. In this way, the system may provide relevant, contextual advertisements to users. In addition, each advertiser may specify a bid value associated with each of the specified targeting criteria. A bid value is an amount of compensation that an advertiser is willing to pay for the presentation of its advertisement to a user.

In another embodiment, at a block 402 content providers provide digital content to the system. Digital content may include audio content, video content, audiovisual content, applications, or other content. At a block 403 the system receives and stores the digital content provided by content providers and the digital advertisement data provided by advertisers. At a block 404 the system makes the digital content provided by content providers available to users. Digital content may be made available via a service offered by the system via a network site, from which users may access content files. At a block 405 a user may request content from the system. The user's request may be in the form of a request to listen to a song, view a video, create a play list, search for a song, search for another user, or another request. A user may discover a particular content file to request by searching one or more databases maintained by the system. A user may limit a search to a particular category or may search all categories. Categories may include artists, tracks, albums, users, all, and other categories. A user may enter one or more search terms into a text box or another input field. The system searches one or more of its databases according to the search terms entered by the user, and displays the matching results to the user. If the system does not find any matches, it may display a message to the user that indicates that no matches were found. A user may also discover a particular content file to request by browsing one or more catalogs offered by the system, being presented with a promotion display, or in another manner.

In another embodiment, at a block 406 the system may provide content, or links to content, to the user. In some examples, a user is required to have an application installed on the user's computer system prior to receiving digital content and advertisements. The required application may be the Zango Search Assistant, provided by Zango, Inc. of Bellevue, Wash., or a similar client-side application. The required application may allow a user to access digital content and may deliver targeted, time-shifted digital advertisements. As described above, an advertisement may be any announcement designed to attract a user's attention, including, but not limited to, a web address to be launched in a browser window by the system. The origin of browser windows containing advertisements launched by the system may be required to be readily identifiable, such as by a title in the title bar of the browser window, the web address in the address bar of the browser window, or another identifiable manner. Time-shifted advertisements are advertisements that are presented separately from content, such as when a user is browsing the Internet or conducting an online search. For example, when a user enters a URL into a browser or conducts a search, such as by entering search terms at a network search site or into an application installed on the user's computer system, an advertisement may be presented to the user based on the search terms, keywords, or URL entered by the user, or based on another targeting criteria. Time-shifted advertisements may also be presented in one or more ways that do not require the use or installation of a client-side application.

In another embodiment, a required application may compel user permission-based installation, such as via Zango's “Safe and Secure Search” (i.e., S3) technology. User permission may be obtained in the form of an End User License Agreement (EULA). The EULA may explain the required application in plain English, so that it is clear to the user what is being installed. These measures may prevent fraudulent installation of the required application without user consent. The required application may be easily uninstalled, such as through the “Add or Remove Programs” menu on a Windows-based computer. The required application may also re-notify each user periodically (e.g., every 90 days) to remind the user that the application is installed, what the software does, and how to remove the application if desired. The required application may also be presented in combination with a fraud reporting mechanism, such as Zango's “Closed Loop System” (CLS), which allows users to report incidents of suspected fraudulent installations. The fraud reporting mechanism may provide the system with the information needed to find fraudulent distributors, notify all affected users, and require affected users to re-opt in to keep the application installed.

At block 407a, in one embodiment, the system provides users the opportunity to request ads (advertisements) from the central server 301. This is typically executed by the user placing the mouse icon, typically in the form of an arrow, over the ad picture and pressing the left mouse button. This will instruct the central server that a particular advertisement has been requested.

At block 407, in one embodiment, the system provides advertisements to the user. In some examples, the system may present advertisements to users via an application that is installed on a user's computer system. In some examples, the advertisements may be time-shifted. That is, an advertisement may not be provided along with the content; instead, the advertisement may be presented separately from the content. For example, when a user enters a URL into a browser or conducts a search, such as by entering one or more search terms at a network search site or into an application installed on the user's computer system, an advertisement may be presented to the user based on the search terms, keywords, or URL entered by the user, or based on another targeting criteria. The system may display to the user the advertisement with the highest bid value for the keyword. For example, if advertiser X has bid $0.05 for keyword 1 and advertiser Y has bid $0.03 for keyword 1, the system will display advertiser X's advertisement. At a block 408 the system receives compensation from advertisers. An advertiser may pay compensation in the amount the advertiser has bid for the keyword associated with an advertisement when the advertisement is displayed to a user. For example, when advertiser X's advertisement is displayed by the system in response to a user entering keyword 1 in a search query, it may pay $0.05.

At a block 409, in one embodiment, the system provides compensation to content providers. The compensation provided to each content provider may vary based on how many users access a service provided by the system during a particular time period or based on other usage data, such as how many times a given content file is accessed. In some examples, each content provider may receive a share of the advertising revenue that is generated by each user that accesses content during a particular time period. In some examples, a content provider may receive a different share of the advertising revenue based on whether it is the content provider's content that enticed the user to use a service offered by the system. For example, if a user installs a required application in order to listen to a song provided by a first content provider, the first content provider may receive a 40% share of the advertising revenue generated by the user. A user of this type, who has not previously installed a required application, may be referred to as an organic or primary user. If a user already has the required application installed and chooses to listen to a song provided by a second content provider, the second content provider may receive a 30% share of the advertising revenue generated by the user. A user of this type, who has previously installed a required application, may be referred to as a non-organic, tertiary, or internal user. In some examples, the amount of revenue received by a content provider may be based on more than one time period. For example, a content provider may be paid based on whether a user accesses content during a given month, but the content provider may receive payment only for those weeks in which the user accesses content. For instance, a content provider may qualify for payment because a user accessed content in month 1. However, the content provider may only receive its share (e.g., 30% or 40%) of advertising revenue for week 1 of month 1 if the user only accessed content during week 1. This may be referred to as breakage. In some examples, content providers may be guaranteed a minimum amount of compensation for each user who uses a service provided by the system during a particular time period. For example, a content provider might be guaranteed $0.06 per user per week or $0.25 per user per month, for all users that access a service.

The system, in one embodiment, may track statistics and offer one or more reports containing those statistics to advertisers and content providers. For example, the system may track, for each advertisement, the number of times the advertisement was displayed, the keyword that triggered display of the advertisement, the amount paid by the advertiser for display, and other statistics. These statistics may be reported to advertisers. As another example, the system may track, for each content provider, the content files accessed by each user; content files saved to each user's personal content library; content files or play lists created, sent, or downloaded by each user; and other statistics. These statistics may be reported to content providers. The system may also track and report other information, including number of registered users, purchase of content files, number of subscribers, and other information.

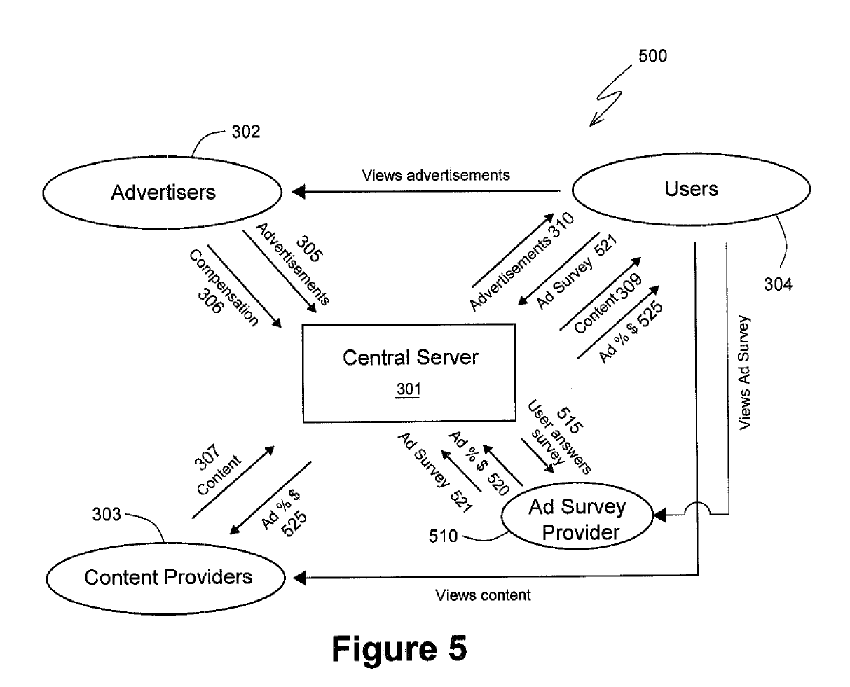

Referring now to FIG. 5, there is illustrated a schematic of one embodiment of the present invention in reference to variations and modifications to what has been presented in FIG. 3. Specifically, in addition to what has already been described, there is a method, system and machine operation 500 for implementing the embodiment of the present invention. There is added an Ad Survey Provider 510, also referred to as an Ad Survey Controller, who creates surveys to gather the Users thoughts and response to the Ads that were created by the Advertisers 302. Thus, when a User views the Ad Survey 521, the Users answer the Survey questions 515. Thereby, after completing the survey questions, the Ad Survey Provider 510 calculates a percentage of the Ad compensation, supplied by the Advertisers, that is to be split between the Users 304 and Content Providers 303. More specifically, a percentage of Ad money (% Ad $) 520 is provided to the Users 304, and the remaining percentage of Ad money (% Ad $) 525 is provided to the Content Providers 303.

It is noted, each of the major nodes of FIG. 5 are controlled by the computer or media machine 100. Specifically, there is an advertiser computer, a user computer, an Ad survey provider computer, and a content provider computer. Each of the computers a coordinated through the central server. Additionally, the arrows indicating viewing relationships are indications of actions by the Users, and are not intended to indicate machine operations, which are all coordinated by the central server.

It is noted, in one embodiment, that this sharing of Ad compensation with Users unlocks the Holy Grail for Advertisers over the internet. This innovative method and system incentivises Users by actually paying them for looking at the ads and answering a few questions about their thoughts on the ad before they get paid. It has typically been a guessing game to figure out what will stimulate consumers to go out and buy a product based on the advertisements. Now, it is possible to get actual consumers to tell the advertisers what they think, and to pay them for their time and information.

Referring now to FIG. 6, in one embodiment, there is a schematic flow chart of detailed steps of the method, system and machine operation 600 involved in what has been outlined in FIG. 5. Specifically, there are two initial steps; first, Content Providers provide content to the central server 602. Advertisers also provide ads (advertisements) to the Central Server 601, and to the Consumer Ad Survey Provider 610, which attaches a link to a created Survey to the Ad, and thus the combination of the Ad plus Survey (written as Ad+$) is provided to the central server 603. Next, the central server stores the content, the Ad, and the Ad plus survey therein 603. The central server makes the content available to users 604. Users then request content from the central server 605. The User receives the requested content 606, whereby the Ads, and Ads plus surveys are attached to the content in known fashion of attaching Ads to web pages on the internet.

At this point in the process, system, method or machine process, the User may not select Ads plus survey 607, i.e. the User request a regular Ad that does not contain any survey element. Thereby, the User receives a regular Ad 622. Thereby the Advertisers provided compensation is paid to the content provider 624. None of the Advertiser money is paid to the User, just like what is done in current systems.

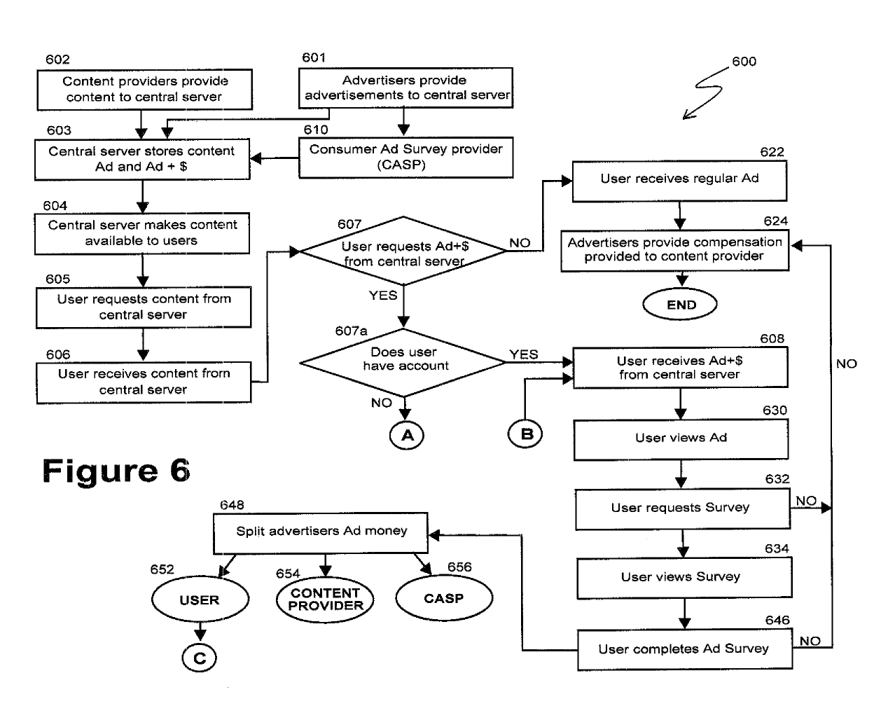

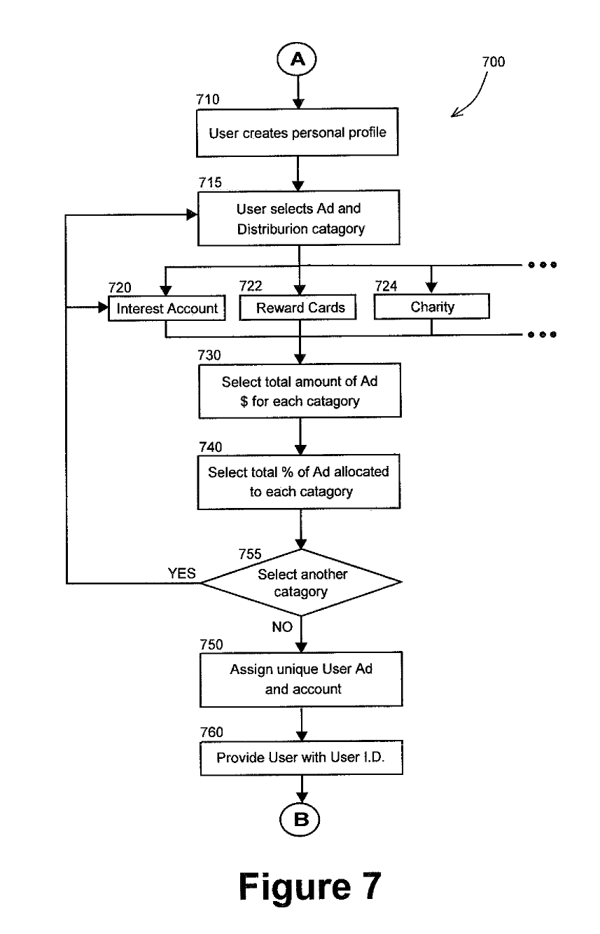

However, in one embodiment, the Users can request a specific Ad plus Survey (Ad+$) from the central server 607. It is then determined if the User has an account 607a. It the User has an account with the Consumer Ad Survey System Provider, the User then receives the Ad plus survey information from the central server 608. If the User does not have an account, the User is directed to set up an account “A”, which is illustrated in FIG. 7. Continuing with FIG. 6, after determining that the User has an account and enters their unique account identification, the User is allowed to view the Ad 630. The User then can either not request the Survey 632, whereby the Advertisers provided compensation is provided to the content provider 624 and the User is done. However, if the User does request the Survey 632, then the User is allowed to view the survey 634. Then the User can elect to not complete the Ad Survey 646, whereby again, the Advertisers provided compensation is provided to the content provider 624. However, if the User does complete the Ad Survey 646, then a percentage of the Ad money is split 648. A percentage of the Ad money is provided to the User 652, a percentage is provided to the Content Provider 654, and a percentage is given to the Consumer Ad Survey Provider 656.

Referring now to FIG. 7, in this embodiment, there is illustrated a schematic representation of a continuation from FIG. 6 from node “A” (an A that is circled) where it has been determined that the User does not have an account to view the survey questions 607a. Specifically, the User first creates a personal profile 710. The typical personal information is gathered for paying people a commission and providing the User with the proper taxation forms at the end of the tax year to account for such payments or earnings. For example, such information collected could be: social security number, address, personal interests, income range, family size, number of cars, personal biometrics like health, weight, age, education, etc. After collection and creation of a personal profile is complete 710, a User is directed to select Ad money distribution categories 715. This is where the User decides how to use their money that is earned by viewing the Ads and answering survey questions. Potential categories are plethora, and may include an interest bearing account 720, which works like a bank savings account that money is placed in and interest is earned on the money for the User.

Another category for Users to divert payments to could be a rewards card 722, which allows the User to buy, for example, a Best Buy® store card. This card could be purchased at a discount by the User, like a $20 card could be purchased for $18 by the User.

Another category for diverting all or a portion of payment made to the User could include the category of charities 724, like the American Hart Association®. By including charities to receive income from the User, there is a new method for a charity to raise money from Users answering survey questions and receiving payment from the Advertisers for such information. Additionally, it is noted, the charity category could also include a matching advertiser contribution. For example, when a User elects to divert say $0.25 of earnings to the selected American Hart Association® charity from answering survey questions about the Ford Motor Company® advertisement, the advertiser, Ford Motors®, could provide, for example, a matching $0.25 contribution to the same charity. This information Advertiser contribution information could be provided to the User upon viewing, for example, the Ford commercial and answering the survey questions. Whereby, the User would see that there is a matching contribution if a portion of the payment is diverted to a specific charity.

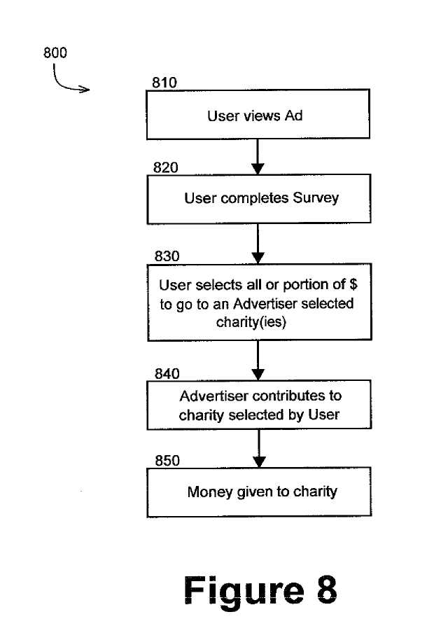

Referring to FIG. 8, in one embodiment, there is illustrated another method of contributing to a charity 800. Specifically, the User first views an Ad+$ on an internet site or page 810. The Ad+$ may also include another symbol indicating that a charity is being contributed to, like a pink ribbon. Thereby, the User completes the survey 820. Whereby, the User is provided a chance to select all or a portion of the Ad money to go to a charity that is listed by and Advertiser 830. The advertiser may list one or many different charities for the money to be diverted thereto. Thereby, the Advertiser's account is set to contribute to the charity selected by the User 840. Thus, the combined money is given to the selected Charity 850.

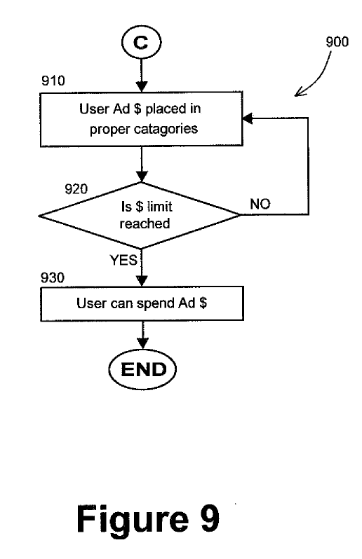

Referring to FIG. 9, in one embodiment, there is illustrated a flow chart of when the User can use the Ad money earned 900. Uniquely, the first step would be that the User Ad $ is placed into the proper categories that were previously selected 910. For example, the User could have selected to put money into a BestBuy® rewards card for $15, where $13 needs to be earned to receive the card. Next, whenever money is received for answering the survey questions, it is determined if the dollar limit has been reached 920. If the limit is not reached, the User must continue placing money into the category. If, however, the limit has been reached, then the User can request the payment and go spend the money 930. In the example provided, the User has earned at least $13, and is sent the rewards card.

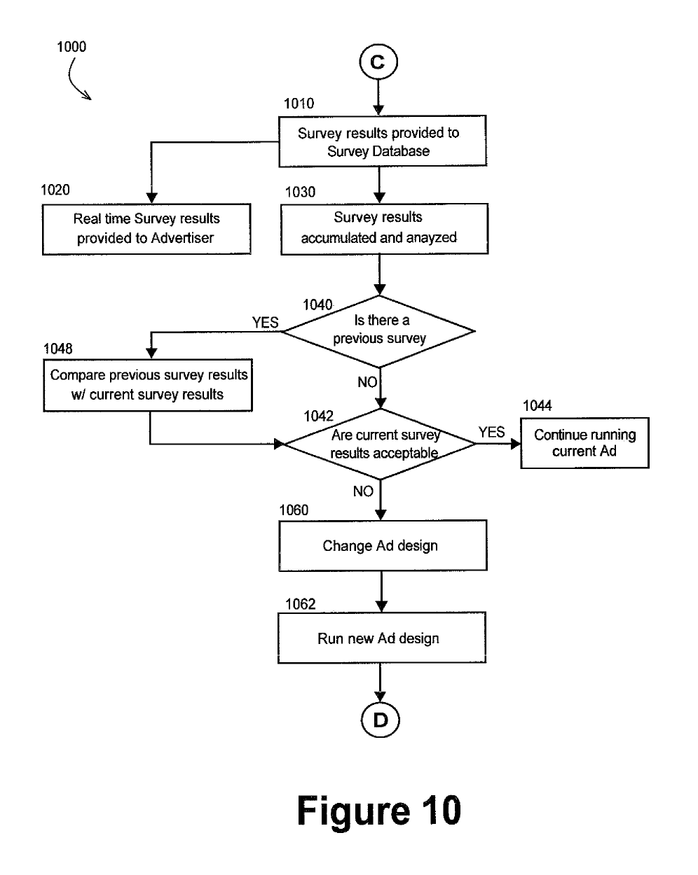

Referring to FIG. 10, in one embodiment, there is illustrated one method for modification and updating the advertisement that is displayed on the content providers web page in response to the collected information from the User answers on the survey 1000. Specifically, after the User completes an Ad survey 646, from FIG. 6, the results are provided to the survey database 1010. Thereby, the real time Ad surveys are provided to the advertisers 1020. Additionally, the survey results are accumulated and analyzed 1030 by the consumer Ad survey provider. Thereby, it is determined if there was a previous survey 1040, and if there is not, the cumulative and analyzed results are provided to the advertiser 1042. Then it is determined if the current results are acceptable 1042; if they are, then the current Ad is continued 1044. If, however, the current Ad results are not acceptable 1042, then the Ad design is changed 1060. Thereby, the new Ad is run instead of or concurrently with the previous Ad 1062. Whereby, the survey results are again accumulated and analyzed 1030. It is again determined if there was a previous survey, and in this case there is, then the new survey results are compared with the previous survey results 1048. Whereby, these new results are determined if they are acceptable 1042 again. Whereby, the survey results and the surveys may be constantly modified and improved to achieve acceptable results to the advertiser.

FIG. 11 illustrates two web page samples using the Ad+$ logos. Specifically, the Kim Komando Show® web page has several advertisements on thereon. There is a Ford, GoToMyPC® and a ’5^{th} Annual Great Giveaway® advertisement located on the upper left and middle right sections. Each of those advertisements have a logo of a bumble bee placed thereon, which is used to act access the Ad+$ system to earn payment for watching the Ad and answering the survey questions.

Similarly, the ESPN® web page has a bumble bee on the CocaCola® advertisement. Whereby, the User can again activate the bee, which will put the user in the advertisement viewing web page and allow the User to answer survey questions to receive Ad money.

Referring to FIG. 12, there is one embodiment of the illustrated invention that illustrates a potential sequence of web pages related to the operation of the illustrated embodiments. In particular, there is shown a generic Yahoo!® web page. On the right side of the web page there is an Ad for the University of Phoenix®.

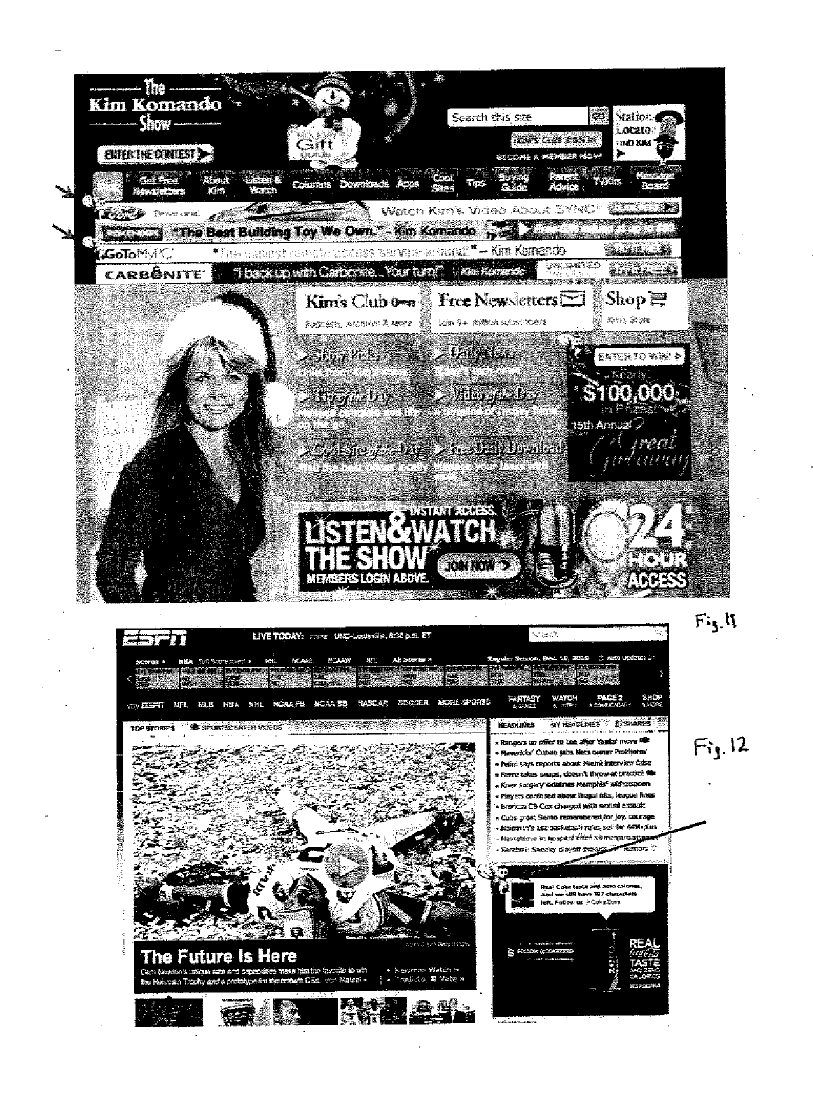

Referring to FIG. 13, there is an enlarged view of the Ad for the University of Phoenix®. Whereby, when the User hovers over the icon, a message appears that shows the amount of the payment and what must be done to earn that money. In particular, there is illustrated that the User must “Watch Ad & Answer 5 Questions” to earn that money.

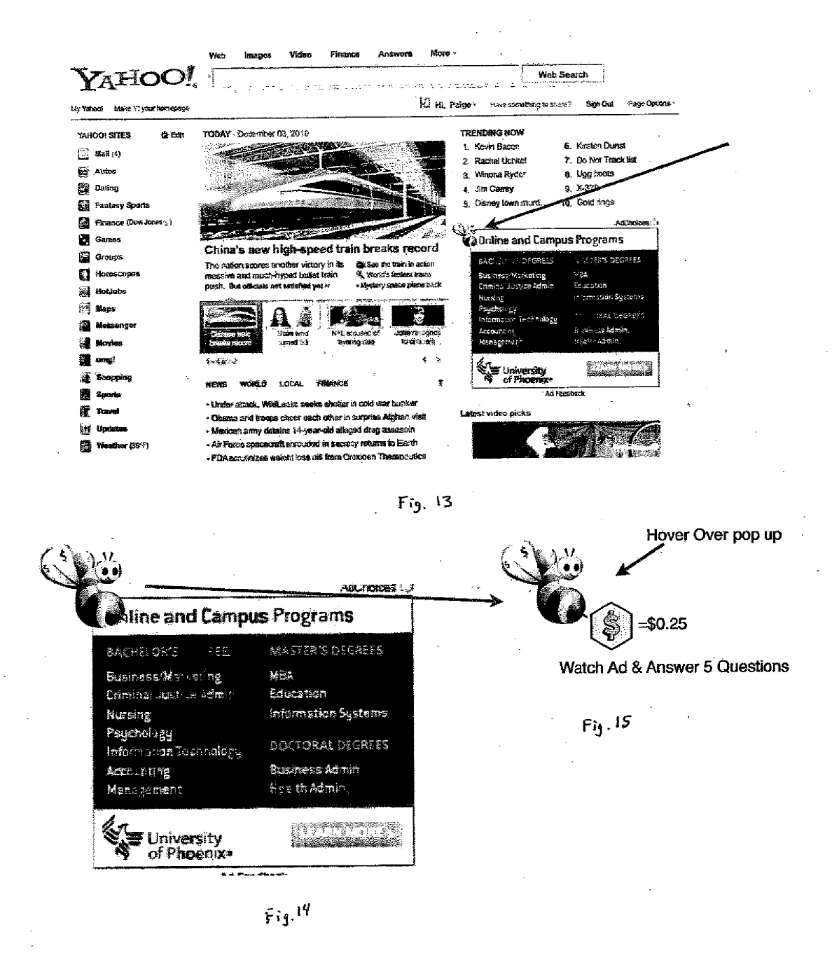

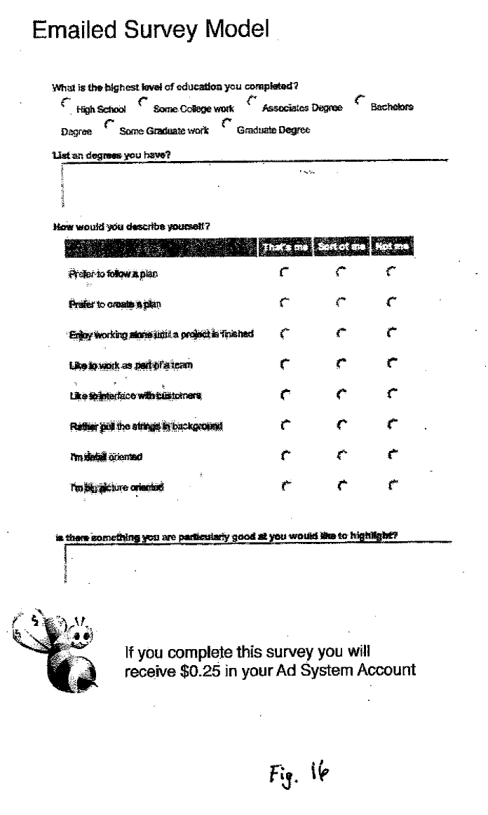

Thus, as shown in FIG. 14, when the User selects the Ad+$ bumble bee on an advertisement about receiving a Bachelors degree on line. Whereby, a few simple questions for the advertiser to learn more about the User's personality and interests to assist the advertiser in connecting interested Users with potential advanced schooling options. It is noted that this survey page also has instructions to the User next to the bumble bee logo, which tells the User that “If you complete this survey you will receive $0.25 in your Ad System Account.”

### Advantages of the Illustrated Embodiment(s)

There are several notable and potential advantages of the presently described and/or illustrated embodiment(s), which provides for a system, method, and machine that enables a user to share in the advertisement revenue. Specifically, the user can now view an advertisement on a computer web page that is created by a content provider and select an advertisement that allows the user to answer survey questions about that advertiser and the particular Ad. Additionally, the user can now be paid an amount of money from the advertiser for viewing the Ad and answering the survey questions. There is a Consumer Ad Survey Provider that coordinates and tracks the advertisers, content providers, and users, and may distribute the allocated money paid by the advertisers, and make payments to the content providers and users.

### Variations of the Illustrated Embodiments

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the illustrated embodiments illustrate only one prescribed flow of processing the various elements, steps and features of the illustrated embodiments, wherein one skilled in the art could design any number of processes for executing the essential elements. Specifically, there is illustrated a single way to enlist a new member to receive an account to get paid by the advertisers for viewing their ads. The main point is that if someone wants to be paid they need to provide the essential contact information to properly be paid.

Additionally, there is illustrated a single way for Users to select the Ad and see the amount of money and number of questions to be answers in the survey. However, it is anticipated that there may be many variations to this step. In particular, the User could be offered a selection of surveys to participate in, where each survey may be of a different scope and complexity or length. Whereby, each survey may even provide a different payment. Thus, a more complex survey may provide more pay, and the less complex or less time consuming ones would pay less. In this fashion, the advertiser can set the price on the information that they find most valuable, and that which is useful but the pricing can be less since most everyone answer those questions.

Additionally, the advertiser can provide varying amounts of payment to charities for answering different surveys or have the same amount of payment. The advertiser may provide a matching payment to that provided by the User, or an alternative amount. The questions could also allow for questions related to other items not related to the advertisers interests, like asking questions about what a person knows of the charity that is being contributed to by the advertiser. It is also possible to have the User not even contribute to the charity and the advertiser does contribute to the charity.

It is also contemplated to provide surveys that are specific to the type of User taking the survey. This option could be based upon the Users profile that was developed by the User to be a member to the Ad revenue sharing system, or be based in part or in whole on past survey participation and answers that were provided. Whereby, it is anticipated that an older aged User would be provided with different questions than a younger aged User. The income range of a User, also, may be used as indices for the type of questions. The type of questions can be tailored to fit many categories of interest to advertisers, like geographic, racial, age, education, sex, hobbies, interests, professions, political affiliations, habits, health, family, activities, car interests, tools, religion, or any other imaginable category.

Further, although only one set of questions are illustrated for a survey, one skilled in the art would understand that any know survey can be requested of the Users and can be designed by the advertisers to collect information that may be useful for marketing information. For example, questions can be presented regarding the impact of the advertisement. Also, questions can be presented about the preferences of the User. Thus, there is no limit to the type or content of the questions that a clever advertiser may want to solicit from the Users.

It is also illustrated many features of different embodiments of the invention that are purely embodied in the figures, attached hereto. Specifically, the special, flow chart positioning of different features are clearly illustrated and are not described in detail, since one skilled in the art of designing web pages, logos, questionnaires would clearly understand these features have an infinite ability to be adjusted. For example, the bumble bee could be most any type of image that can indicate that a survey is attached to the main advertisement and that money may be earned for answering the survey questions.

It is also described that the public computer network, i.e. the internet, is the means of connecting the various entities together in the system described in the above specification. However, in reality, the illustrated embodiments may work on any known or yet to be developed infrastructure that allows different computers or machines to communicate to each other.

Although the illustrated embodiment(s) describe the use of money being paid to the User and the content provider, other methods are available. For example, an amount of proportionate credit, points, bumble bees, honey cells, etc. may be provided from the advertiser to be used by the ad survey controller 510 that in turn is provided to the content provider and User upon completing the survey. Thus, when enough honey cells are collected the User may get a $15 redeemable coupon for ice cream.

The specification uses the wording of “computer”, “module” etc. to describe components of the illustrated embodiments. However, the skilled artist could visualize how these components could be describing the operation of a machine, apparatus, system, or any other of contraption that provides the described benefits and features described herein.

Thus, while the present illustrated embodiment(s) has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is desired to be claimed as Letters Patent under the United States Constitution, Article 1, section 8, clause 8, “To promote the progress of the science and useful arts, by securing for limited times to authors and inventors the exclusive right to their respective writings and discoveries”, is set forth herein after:

1. A user payment system coupled over a public communication network, designed to automatically enable an advertiser to pay a user for answering a survey question placed on a content provider web page and managed by an ad survey controller, comprising:
a) a central server module, coupled to the internet, having a server engine module, a web management module, and a content management module;
b) an advertiser module, coupled to the central server via the public communication network, designed to provide an advertisement to the central server module, and to provide advertising compensation;
c) a content provider module, coupled to the central server module via the public communication network, designed to provide a web page of content to the central server;
d) an ad survey controller module, coupled to the central server module via the public communication network, designed to provide a survey question to the central server module, wherein the survey question is associated with the advertisement; and
e) a user module, coupled to the central server module via the public communication network, designed to enable the user to view the advertisement and answer the survey question, whereby the user is paid a portion of the advertising compensation upon completing the survey question.

2. A system of machines, designed to display an advertisement on a web page of a content provider to a user, and enable the user to be paid to answer a survey question, coupled to the advertisement, provided by an ad survey controller, the machine comprising:
a) a central server machine, designed to provide communication between the advertiser, ad survey controller, content provider, and user;
b) a content provider machine, coupled to the central server machine, designed to provide content to the central server machine;
c) an ad survey controller machine, coupled to the central server machine, designed to provide a combined advertisement and survey question to the central server machine; and
d) a user machine, coupled to the central server machine, designed to access the content and the combined advertisement and survey question that are attached to the content, designed to, when the survey question is completed, cause the ad survey controller machine to move an associated credit to the content provider machine and the user machine.

3. An apparatus, designed to attach a combined ad and survey to a web page, and enable a user to get a credit after completing work on the survey, the apparatus comprising:
a) a content provider apparatus, having a content provider account, and designed to create and provide a web page to the user;
b) an ad survey apparatus, designed to attach the combined ad and survey to the web page; and
c) a user apparatus, coupled to the content provider and ad survey apparatus, designed to cause the ad survey apparatus to create a credit for the content provider and user apparatus when the survey is completed.
